(19) United States
(12) Patent Application Publication
(10) Pub. No.: US 2006/0289779 A1
(43) Pub. Date: Dec. 28, 2006

(54) Uv radiation detection and warning apparatus and method

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/571,622

(22) PCT Filed: Oct. 6, 2004
(86) PCT No.: PCT/IB04/51997

§ 371 Date: Mar. 14, 2006

Related U.S. Application Data
(60) Provisional application No. 60/509,822, filed on Oct. 9, 2003.

(51) Int. Cl. G01J 1/42

(52) U.S. Cl. 250/372

(57) ABSTRACT

An ultraviolet radiation indicator system includes a wireless telephone adapted communication with wireless communication network having a positioning system, such as an enhanced emergency services function. A plurality of radiation sensors that sense ultraviolet radiation are arranged in predetermined areas. The radiation sensors are adapted for communication with the wireless communication network. The wireless communication network provides at least an ultraviolet radiation index (UV index) based on readings from the sensors located closest to the wireless telephone, with the UV index being transmitted to the wireless telephone. In the event the wireless telephone is far enough away from the closest sensors to cross a threshold, then the user is sent general information from the Weather Bureau for a particular geographic designation, such as a zip code, city, portion of city, etc. The ultraviolet radiation indicator can provide the UV index to the wireless telephone upon a user request received from the wireless telephone, or the user may subscribe to the surface. Alternatively, the user may receive unsolicited updates for a period of time subsequent to the first request, or when conditions change significantly.

The present invention relates to detection and warning systems. More particularly, the present invention relates to a UV radiation detection system.

Health professionals, as well as the general public, are becoming increasingly aware of the harmful effects that an extended exposure to sunlight has on human skin. The ozone layer, which acts as a filter to reduce the amount of ultraviolet light present in sunlight that makes it to the Earth's surface, is thinning (there is even an opening at the North Pole). By most standards of measure, the amount of harmful rays present in sunlight continues to grow, increasing the risk of skin cancer, and otherwise generally aging the skin and causing spotting and wrinkles. Excessive exposure to ultraviolet light is now linked to an increased probability of eye damage, particularly cataracts, which is why eye glasses coated with a UV blocking material has become very popular. UVB radiation is a specific band of ultraviolet light that is considered particularly harmful to humans.

As result of all the warnings both by doctors and the media, people now tend to spend less time in the sun even during their holiday. When they do spend time outdoors it is common for people to use a sunscreen with an SPF (Sun Protection Factor) which usually gives an indication of how strong is the protection.

However, the majority of people are still unsure of what is the difference in protection between a 30 SPF lotion and a 60 SPF lotion (it is not a linear scale), and whether or not the lotion is “water proof” or at least water resistant, and how often it should be re-applied depending on the duration the person is swimming, perspiring from physical activity (or just from the heat), etc.

In addition, there are additional conditions, such as environmental conditions, time of day, sunlight intensity, wind, etc., all of which can affect how much sunscreen should be put on and how often it should be reapplied.

There are some portable devices that do not actually measure the UV but rather calculate how long one should stay in the sun based on the ambient condition information input to the device. For example, U.S. Pat. No. 5,365,068 discloses a device that calculates certain information that is associated with sunburn and damaging skin. This portable device requests the user to identify how long they plan to stay in the sun, what is the user's skin type, and based on entries regarding the ambient conditions (i.e. sunny, cloudy, etc.) the device recommends an optimal level of SPF (sun protection factor) that should be used, the amount that should be applied, etc. These types of devices do not consider other factors such the quantity of UV light peaks from the hours of 11 A.M. to 2 P.M., and that during a period from approximately the beginning of spring to the summer, the UV levels are approximately two to three times greater than in December, when the UV is at a minimum.

There are also simple methods and devices that exist for actually measuring UV radiation, for example, in the form of UV cards, but generally they are not very accurate. In addition, these cards also represent another additional item that people have to remember to take with them when they go out. More expensive devices provide more accurate measurements but these devices tend to be larger in size than the cards, making it all the more unlikely for people to carry them around. In addition, UVB light is felt to be the most damaging to humans of all the light in the UV spectrum, so the monitoring device should be able to discriminate between UVA and UVB, for example, in order to get the most accurate indication possible. Thus, an individual measurement device needs to have certain capabilities that increase its costs to the point where the typical sunbather is either cannot or will pay for such a measuring device.

It is known that cellphones have become everyday objects and one can assume that as objects most likely to be found on people at any place and occasion (similar to a wallet). In addition, cellphone networks by definition (due to their working principle) and most recently by upgrades applied for enhanced emergency services, can be used to determine the geographic location of a cellphone in the network. Thus, in case of emergency such as illness, a person can be located by the cellphone network in a fashion similar to determine a location using GPS but with much less accuracy.

The present invention exploits the geographic location feature of cell phones by providing a UV radiation report that can be individualized to the location of a particular cellphone, or area.

In a first aspect of the invention, the network provider can receive conditions regarding UV radiation from a local weather forecast station and transmit the appropriate UV report to the user's cellphone. This could be an alphanumeric call or page, or it could include audio that announces the UV level. The report could be sent to a person's cellphone periodically or upon an activation request by the user.

Thus a user can find out quickly and accurately the UV index for their particular area. This information can be provided, for example, by a weather forecasting service that monitors area of particular interest regarding sunburn, such as public beaches, or by broadcasting to the user the UV index for a particular zip code, predetermined zone, cell area, etc.

In another aspect of the present invention, a system involves a subscriber service, cell service, or government entity setting up UV detection devices. These devices would then relay the information to a central cite, which in turn, when requested, could provide individuals with localized UV index information on their cellphone that is far more accurate than the weather forecast from the night before or the morning of that particular day.

In yet another aspect of the invention, the user is informed about a level of UVB information, which is thought to be particularly harmful to human skin and eyes. Along with the UV information, recommend SPF levels for suntan lotion, and recommended maximum exposure time in the sun can be provided. Also, if the user, for example, doesn't have suntan lotion with an SPF of 45, the system can broadcast how long exposure is recommended if one has suntan lotion with an SPF of 30. For example, the communication network can transmit to the wireless telephone a recommended maximum duration time for exposure to ultraviolet radiation based on the UV index determined in the vicinity of the wireless telephone, wherein the maximum duration time includes a first time period based on no SPF lotion has been applied and a second time based on application of the proper SPF.

According to another aspect of the invention, a user may enter an SPF rating of an available SPF lotion and the communication network corresponds with a third time period based on the rating of the available SPF lotion.

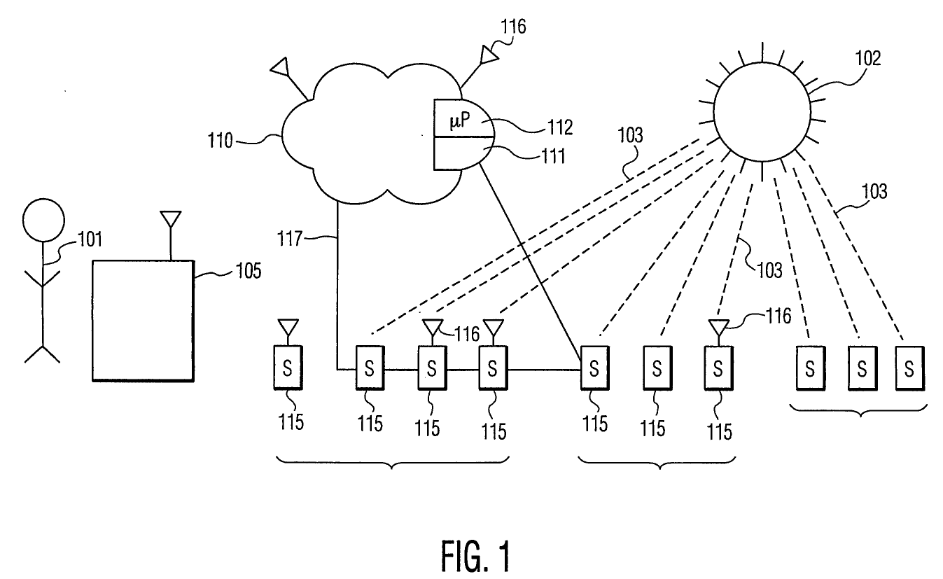

FIG. 1 is an illustration of a UV indication system according to a first aspect of the invention.

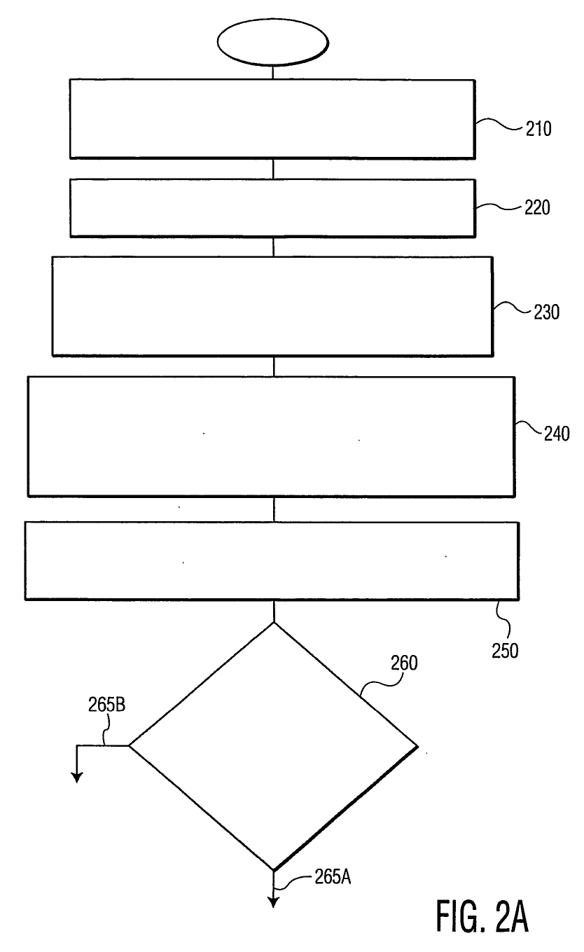

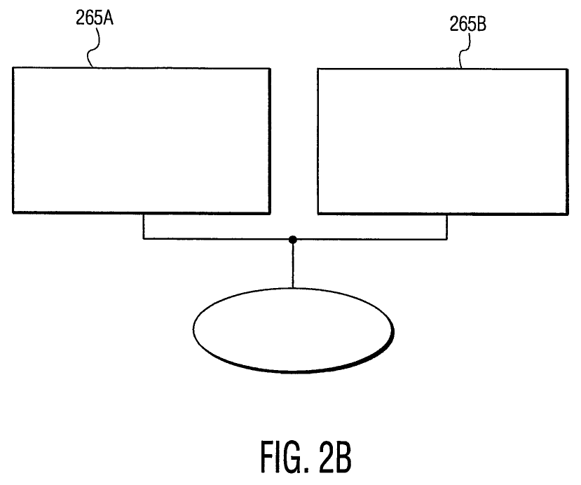

FIGS. 2A and 2B illustrate a method according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 is an illustration of a first aspect of the present invention. A user 101 having a cellphone 105 (not drawn to scale) is in an outdoor area that is closest to Area A (Areas B and C are also shown). The sun 102, along with daylight, also transmits ultraviolet light. Each area has a plurality of sensors 115 that are specifically designed for sensing ultraviolet light. For example, U.S. Pat. No. 5,387,798 to Funakoshi et al., which is hereby incorporated by reference as background material, discloses a UVA-UVB discriminating sensor. While it is preferable that a sensor discriminate between UVA and UVB because UVA exposure causes human skin to darken, whereas UVB is the far more harmful UV light that is associated with freckles, blisters, skin cancer, and cataracts, a simple UV sensor could also be used, particularly if costs need to be controlled.

The sensors 115 communicate with network 10, which has or communicates with a positioning system 111 and a microprocessor 112 for analyzing sensor data, either via fiber optic link or copper link 117, or via wireless communication through antenna 116. The sensors, for example, can change color when exposed to different amounts of ultraviolet light. This change can be sensed by a photosensor and converted into distinguishable levels of current to be fed back as wireless or optical, electrical signals to the network 110, which then can analyze the levels, find the UV index, and make appropriate recommendations with regard to recommended exposure times to the sun and/or amount of SPF that needs to be worn.

The sensors, in this particular aspect of the invention, are envisioned to be arranged along, for example, the boardwalk of public beach, at different areas of public playgrounds, at outdoor arenas and stadiums, volley ball courts, ballfields, i.e. anywhere that is deemed to be a popularly frequented area that normally includes activity that is conducive to one getting exposure to the sun.

The three areas (A-C) are chosen merely for illustrative purposes, and a person of ordinary skill in the art should not infer any limitation with regard to the number and type of sensors, and/or the number and type of sensors. Each of these three areas are at a slightly different angle to the sun, and as a result, may not have the same levels of UV light. In addition, it is possible that there are objects, such as trees, hills tall buildings, etc., that interfere with receipt of direct sunlight at a given point. Thus, according to an aspect of the invention, the plurality of sensors closest to the cellphone is used to determine the UV index, as this is in all likelihood the most closely associated level that is experienced by the user.

The user 102 receives an indication of, for example, the UV index on his/her wireless telephone 105. While the term telephone has been selected for the description, for purposes of the scope of the invention, and scope of the appended claims, it is to be understood that in this particular instance a wireless telephone is merely a generic term, and the device may comprise a PDA, such as a Palm Pilot, a handheld or notebook computer with or without a telephone function, a pager, which may be an audio pager, visual pager (alpha-numeric) or any combination. What is necessary is either at least one of an audio or a visual display.

The user 102, in a first aspect of the invention, can dial a certain number and receive the readings directly on his/her cellphone. This number queues the network into providing the UV readings. In other aspects of the invention, the user may subscribe to a service and automatically receive the transmissions when they are within range of the network. Finally, it is also envisioned that the cellphone within range could receive a broadcast of the levels detected by the nearest sensor or sensors. With an actual wireless telephone, for example, this data could be transmitted via the SMS (short message service) of a cellphone. The information could be transmitted in, for purposes of illustration and not for limitation, CDMA, TDMA, GSM, QDMA.

It is also envisioned that the network is a wireless LAN operating under a protocol, for example, such as 802.11. Both the sensors and the telephone (or other applicable communicator) are devices associated with a particular WLAN, and the telephone receives communication from the network based on a predetermined number of sensors 115 that are within a certain number of feet, such as a radius, or within a certain signal strength of the telephone (for example, based on a pilot signal strength determined by a Base Station Controller (BSC) that communicates with the WLAN.

Wireless telephones 105 now have a preferable feature in that many now have enhanced emergency services for calls to police, fire, etc (911) so that appropriate personnel can determine where the caller is located. Often, in a wooded area or after a crash in the dark, people may either be unfamiliar with the area or disoriented with regard to their location. This feature, which can be turned on as well to locate missing persons, can also be used to determine a location of the telephone, and thus, its owner 101. Then, a reading based on the sensors 115 closest to the telephone, in this case, the sensors in AREA A, but not Area B or Area C, are used to calculate UV index, etc.

The user may receive data such as the UV index and SPF data only after specifically requesting it, or he/she may receive additional updates by programming, or when it has been determined that there is a serious change in the UV index. The users cellphone could beep, ring, etc. and the new data can be displayed on the face of the phone. Alternatively, once a maximum or recommended time has passed, the network may signal the telephone with an indication that additional exposure to the sun is not recommended. It is also clear how another aspect of the invention can be to notify a person or persons when they have received an adequate amount of sunlight sufficient to synthesize quantities of vitamin D in the average human that are acceptable. Vitamin D plays an important role in bone development, and there have been several well-documented studies showing a possible link between lack of exposure to the sun during winter months over an extended period and an increased risk of contracting multiple sclerosis. Throughout the world, people from different continents are at increased risk when their winter time sun exposure is low. There are also disorders, such as SAD, in which the medical profession is prescribing a certain amount of exposure to light as a remedy. The presently claimed invention would be ideal for any of these purposes as it would provide the user with accurate information and not require one to carry around a monitor, sensor, etc. The cellphone would be all that is required on the user's part.

FIGS. 2A and 2B illustrate a method according to the present invention.

At step 210 a network for a wireless telephone is provided. The network should have a positioning capability, such as Enhanced Emergency Services and/or GPS, or any other positioning system may suffice. The Enhanced Emergency Services offer the advantage that they are already part of a cellphone network, so protocol to develop GPS or some other positioning system is not required.

At step 220 a plurality of sensors are arranged in a plurality of areas. As discussed above, this could be high-traffic areas for outdoor exposure, such as beaches, parks, public pools, playgrounds, outdoor arenas, etc. The sensors can be, for example, arranged along the boardwalk of a beach, on the roof tops of local beachfront hotels, etc. The sensors could also be arranged in the ground, and in such cases should be located somewhat to the side of normal pedestrian traffic. The ground sensors may also incur a problem in that someone could step on them, place objects on them and/or otherwise stand between the sensors and the sunlight and cause the sensors to give incorrect readings. For this reason, placement on street lamps, posts, etc. is preferred. False readings are also another reason why it is preferred to use a plurality of sensors in each area, so that the network can either average or discard the highest and lowest readings.

At step 230 the sensors from each area report the sensed data back to the network for processing. These sensors can be connected wirelessly to the network, or they may connect via optical fiber, or even copper wire. In any event, the sensors' output needs to be sent to the network (i.e. a controller) that in all likelihood will process the data. However, it is possible that the processing occur locally, but this would increase costs of the system.

At step 240 the network calculates for each area at least one of the UV index, and/or a recommended exposure time. Based on the UV index, this data can be cross-referenced with a table that indicates the recommended SPF lotion to be used for each value of the index, and the maximum time before burning typically occurs. The table may also contain equivalents to the SPF, so that, while, for example, SPF 30 lotion might be recommended, if someone has SPF 15 the network will reduce the time of the recommended exposure. It should be noted that in some instances a sliding scale of SPF versus time might not be favored by dermatologists, but in reality most people tend to have either only one type of lotion, or have one very strong one, such as 30, and a lower number, such as 15, for use after several days of exposure.

At step 250, upon a request from a wireless telephone, the network will determine the location of the wireless telephone and a distance of sensors that are closest to the wireless telephone. This request could be activated by the user pushing a function key on their cellphone, or dialing a certain number dedicated to using this feature. Alternatively, a user may put the cellphone into a sun-monitor mode which automatically provides the information and updates every predetermined time period, or when the information has changed by a certain threshold amount.

At step 260, there is a decision as to whether the distance of the sensors closest to the wireless phone is greater than a predetermined threshold? If the answer is yes, then the readings might not be applicable, or could indicate less UV exposure than what is actually present at the user location due to the difference in positions. A t such a point, or where there are no sensors installed, the UV indication may be based on weather bureau forecasts for the closest city, part of the city, town, zip code, or other geographic designation. It is also possible to place sensors beside the cellphone towers, and use the closest cell area. Thus, step 265A would be applicable. In this case, it might be advised to let the user know the indication is a general UV indication.

However, if the distance to the sensors closest to the wireless telephone is not less than the predetermined threshold, then the network can transmit the data based on the sensor readings deemed closest. In this regard, it should be understood that the processing of the sensor data may only occur when a user requests information, so as not to waste processor time churning away at calculations for all the different areas when there aren't any users requesting the information. Alternatively, the UV index data (and SPF data, etc.) can be stored in a table that is updated every predetermined interval of time.

Various modifications can be made by a person of ordinary skill in the art to the present invention that does not depart from the spirit of the invention or the scope of appended claims. For example, while only three or four sensors per area are shown, depending on the cost, there could be fewer, or literally hundreds of sensors. The number of areas, the size of the areas can all be varied to suit user need. As previously discussed, the term wireless telephone and cellphone can be used interchangeably, and it should be understood that reference to cellphone or wireless telephone in the specification and the appended claims includes but is not limited to PDAs, pagers, notebook computers with wireless transmission capability, virtually any device that is used to communicate voice and/or visual data. The sound system and/or the visual display is used to communicate the UV index information. For example, it can be displayed on the cellphone screen, computer screen, PDA screen, Pager screen, or listened to by the speaker on the telephone, computer, pager (if applicable), PDA, digital communicator, etc.

What is claimed is:

1. An ultraviolet radiation indicator system comprising:
a wireless telephone (105) adapted for communication with a wireless communication network (110) having a positioning system (111);
a plurality of radiation sensors (115) that sense ultraviolet radiation being arranged in predetermined areas, wherein the radiation sensors (115) are adapted for communication with the wireless communication network (110);
wherein said wireless communication network (110) provides at least an ultraviolet radiation index (UV index) based on readings from the sensors located closest to the wireless telephone, said UV index being transmitted to the wireless telephone (105).

2. The ultraviolet radiation indicator system according to claim 1, wherein said wireless communication network (110) provides said UV index to the wireless telephone (105) upon a user request received from the wireless telephone (105).

3. The ultraviolet radiation indicator system according to claim 2, wherein the wireless telephone (105) includes a predetermined setting requesting updated UV index reports of a predetermined number over a predetermined period of time.

4. The ultraviolet radiation indicator system according to claim 3, wherein the communication network (110) automatically transmits a warning to the wireless telephone (105) when the UV index exceeds a certain predetermined threshold.

5. The ultraviolet radiation indicator system according to claim 3, wherein a user additionally requests the communication network (110) to begin timing a period of exposure to ultraviolet light, said communication network transmitting a signal to the wireless telephone (105) indicating when a maximum recommended exposure time to ultraviolet light has reached a predetermined threshold.

6. The ultraviolet radiation indicator system according to claim 1, wherein said wireless communication network (110) transmits to the wireless telephone (105) a recommended sun protection factor (SPF) for sunburn/suntan lotion to be applied in the vicinity of the wireless telephone (105).

7. The ultraviolet radiation indicator system according to claim 6, wherein said wireless communication network (110) transmits to the wireless telephone (105) a recommended maximum duration time for exposure to ultraviolet radiation based on the UV index determined in the vicinity of the wireless telephone (105), said maximum duration time includes a first time period based on no SPF lotion has been applied and a second time based on application of the proper SPF.

8. The ultraviolet radiation indicator system according to claim 7, wherein a user enters a rating of an available SPF lotion and the communication network (110) corresponds with a third time period based on the rating of the available SPF lotion.

9. The ultraviolet radiation indicator system according to claim 1, wherein the positioning system (111) comprises a Global Positioning System that is used to determine a location of the wireless telephone (105) so as to provide information based on radiation sensors that are a shortest distance from the wireless telephone.

10. The ultraviolet radiation indicator system according to claim 1, wherein the positioning system (111) comprises said means for determining a location of the wireless telephone (105) according to a strongest received signal strength of a base station controller out of one or more base controllers that can communicate with the wireless telephone (105).

11. The ultraviolet radiation indicator system according to claim 10, wherein the signal strength received by the positioning system (111) comprises a pilot signal from the wireless telephone (105).

12. The ultraviolet radiation indicator system according to claim 11, wherein the wireless telephone (105) is adapted to receive a wake-up/power up message from a power reduction mode and/or a power up mode message via the pilot signal if an emergency message regarding exposure to ultraviolet light requires transmission to the wireless telephone.

13. An ultraviolet radiation indicator system comprising:
a wireless telephone (105) adapted for receiving information regarding at least one of an ultraviolet radiation (UV) index that indicates a level of ultraviolet light sensed, and a sunlight protection factor (SPF) number that indicates a recommended SPF suntan/sunburn lotion for use outdoors;
a plurality of sensors (115) that sense ultraviolet radiation, the sensors being arranged in a plurality of predetermined locations where knowledge of at least one of the (UV) index and the (SPF) number is desired;
a microprocessor (112) that receives information from the plurality of sensors (115) in at least one predetermined location and determines at least a (UV) index; and
a transmitter (116) in communication with the microprocessor for transmitting said at least one of the (UV) index and the (SPF) number to the wireless telephone (105).

14. The ultraviolet radiation indicator system according to claim 13, wherein said at least one of the (UV) index and the (SPF) factor is transmitted using a SMS (short message service) frequency of the wireless telephone (105).

15. The ultraviolet radiation indicator system according to claim 13, wherein said at least one of the (UV) index and the (SPF) factor is transmitted to the wireless telephone (105) using one of CDMA, TDMA, and GSM.

16. The ultraviolet radiation indicator system according to claim 15, wherein the plurality of sensors (115) and the microprocessor (112) communicate via an IEEE 802.11 wireless protocol.

17. The ultraviolet radiation indicator system according to claim 13, wherein the plurality of sensors (115) and the microprocessor (112) are linked via one of optical fiber (117) and copper wire.

18. The ultraviolet radiation indicator system according to claim 13, wherein the plurality of sensors (115) monitor (UV)B ultraviolet radiation.

19. An ultraviolet radiation indicator comprising:
a wireless telephone (105) adapted for receiving information regarding at least one of: (1) an ultraviolet radiation (UV) index that indicates a level of ultraviolet light sensed, (2) a sunlight protection factor (SPF) number that indicates a recommended SPF suntan/sunburn lotion for use outdoors, and (3) a recommended exposure time in the sunlight;
wherein said wireless telephone (105) includes an enhanced emergency services function identifying its physical location to permit receipt of information associated with said at least one of the (UV) index, the recommended SPF suntan/sunburn lotion, and the recommended exposure time in the sunlight for a particular physical location closest to the wireless telephone (105).

20. A method for providing ultraviolet radiation indication, comprising the steps of:
(a) providing a communication network for communication with a wireless telephone having a positioning system (210);
(b) arranging in predetermined areas a plurality of radiation sensors that sense ultraviolet radiation, wherein the radiation sensors are adapted for communication with the communication network (220);
(c) sensing a level of ultraviolet radiation and providing a result to the communication network (230);
(d) said communication network calculating at least one of an ultraviolet radiation index (UV index), a recommended sunlight protection factor (SPF) lotion used to protect skin from sunburn, or a recommended exposure time to the ultraviolet radiation (240);
wherein said communication network provides the information recited in step (c) to a wireless telephone based on readings from the sensors selected from the plurality of sensors that are located closest to the wireless telephone, said information being provided to the wireless telephone subsequent to a user keying a predetermined code or requesting a UV indication level by activating a function key (250).

21. The method according to claim 20, wherein step (d) includes comparing a distance of the closest plurality of sensors to the wireless telephone located with a predetermined maximum threshold distance, and if that distance is greater than the predetermined maximum threshold, providing the information regarding UV index and SPF by one of zip code, geographical area, city, section of city (260, 265A, 265B).
